(19) United States
(12) Patent Application Publication
(10) Pub. No.: US 2002/0138419 A1
(43) Pub. Date: Sep. 26, 2002

(54) Structured leasing method and system

(76) Inventors: Thomas Melone, Upper Saddle River, NJ (US); Mark R. Yanowitz, Mendham, NJ (US); Brad L. Wilson, Scarsdale, NY (US)

Correspondence Address: DICKSTEIN SHAPIRO MORIN & OSHINSKY LLP, 2101 L STREET NW, WASHINGTON, DC, 20037-1526, US

(21) Appl. No.: 10/102,725

(22) Filed: Mar. 22, 2002

Related U.S. Application Data
(60) Provisional application No. 60/277,631, filed on Mar. 22, 2001.

(51) Int. Cl. G06F 17/60

(52) U.S. Cl. 705/38

(57) ABSTRACT

A method and system for structuring, developing, administering and managing by a computer lease transaction which involves deferring cash rents over a first period of time, prepaying cash rents in order to cover a second period of time; and creating a pre-paid rent loan for the remaining term of a lease by making a further prepayment.

### FIELD OF THE INVENTION

The present invention relate to a method and system for structuring, developing, administering and managing structured leases.

### BACKGROUND OF THE INVENTION

Users of real or personal property must determine whether it is advantageous to be the owner of the property or to be a lessee. In many cases, a lease provides an attractive alternative to outright ownership. In a typical lease transaction, the party who desires to use the real or personal property (the “Lessee”) will, itself or through an intermediary, seek another party (the “Lessor”) who will purchase the real or personal property, and then lease the real or personal property for a fee, over a term. The Lessor's initial investment in the real or personal property is typically recovered through the rent payable and through either (i) the residual value of the property at the end of the lease term or (ii) sale of the property to the Lessee at the end of the lease term. At the end of the term of the lease, the Lessee often has the option to purchase the leased real or personal property at a fixed purchase price determined at the inception of the lease.

Typically, the leasing transaction includes a third party lender (“Lender”), which lends a substantial portion of the purchase price of the real or personal property to the Lessor. The rent payable by the Lessee is then sufficient to enable the Lessor to repay the debt and provide a satisfactory return to the Lessor on its investment.

As a consequence of the lease transaction, the Lessee can often obtain the use of the subject real or personal property for a lower aggregate cost than if the Lessee were to pay for or borrow the property's purchase price. For the Lessor, two financial benefits are achieved: First, the aggregate payments received from the Lessee will fully amortize the initial purchase price of the real or personal property plus an increment to reflect the cost of funds. Second, the Lessor may be able to realize federal and state income tax deductions as a consequence of its ownership of the real or personal property that is the subject of the lease. Particularly in cases where the Lessee is not paying US federal or state income taxes (e.g., the Lessee is not generating taxable income in its business operations or is a tax exempt entity), the tax benefits that would inure to the owner of the property are of no value to the Lessee. In this case, through the use of lease financing, the tax benefits are recognized by the Lessor who can then effectively pass back a portion of those benefits to the Lessee through lower rentals.

A Lessor recognizes taxable income on the rent it receives, and receives interest deductions on the interest it pays to the Lender. The Lessor is also entitled to depreciation deductions attributable to the cost of its investment. In a typical leveraged lease transaction, the Lessor wishes to recognize deductions as early as possible and to defer recognition of taxable income. There are a vast number of leasing companies (typically banks, finance companies or finance subsidiaries of large corporations) who have utilized the tax benefits of leasing transactions for over thirty years. The leasing business has become a large business and a significant percentage of the assets acquired for business use in the United States and elsewhere in the world are acquired through lease transactions.

As this market has developed, through numerous court cases, the U.S. Internal Revenue Service (“IRS”) guidance and through customs in the industry, various rules have become accepted parts of the leasing business. In structuring a leveraged lease, following these rules is necessary in order for Lessors to become comfortable that the transactions will be respected as “true leases” rather than recharacterized as loans or shams for tax purposes. Characterization as a true lease rather than as a loan or a sham is a prerequisite for the Lessor to enjoy the tax benefits associated with a leasing transaction. One of these rules that have become an accepted part of leasing industry practices is to limit the loan balance to a percentage of the leased asset's fair market value from time-to-time. Thus, many Lessors will require that the lease financing be structured such that the amount owed to the Lender at any time cannot exceed a specified percentage (often 90-95%) of the asset's fair market value at such time (referred to herein as the “loan to value constraint”).

Prior to March 1999, the Lessor accrued its rent income from the lease on a basis where the income was recognized at the time the cash rent was actually received. However, the tax rules created certain restrictions. In order for the Lessor to avoid an IRS recharacterization of the rental income timing that could require income to be recognized before the cash was actually received (which results in adverse tax consequences), the lease rentals were required to meet a 90-110 test: rents for each year could not be less than ninety percent or greater than one hundred ten percent of the average rent. Thus, if the average rent for a ten-year lease was $1,000 per year, the rent for any year could not be less than $900 or exceed $1100 for any given year.

In March 1999, the IRS liberalized the way that a Lessor could allocate and report rent. See U.S. Treas. Reg. Section 1.467-1 et. seq. In particular, under this Section, a taxpayer was allowed to separate the timing of when the rent was actually paid from the time when the income was accrued for tax purposes, subject to meeting various restrictions. Under one of these rules (Treas. Reg. Section 1.46-2), the IRS allows Lessors to receive the cash rent allocated to a particular calendar year at any time during the preceding, current and succeeding calendar years in which the lease exists without requiring any interest charge to reflect the difference between when the income was reported for tax purposes and when the cash was received. This regulation therefore created, in effect, a disconnect between the lease payments received by the Lessor and the income taxes payable on those lease payments. The above-noted IRS regulations still require that the allocations of rent meet the so-called 90-110 test in order to qualify for a safe harbor from IRS recharacterization Treas. Reg. Section 1.467-2 also provided for rules where the cash rent allocable to a particular calendar year was not paid within that year, the previous year or the succeeding year. Under this rule, in the case where rent was prepaid (i.e., the cash received by the Lessor was in excess of the taxable income reported), the Lessor is required to treat the prepayment as a loan (a “Prepaid Rent Loan”) and to pay interest on the Prepaid Rent Loan balance in order to avoid certain adverse tax consequences.

Even though the March 1999 regulations have added flexibility to the manner in which lease payments are allocated in comparison to the way that cash is received, current practice is still limited. In general, most leases reflect a structure where the first part of Treas. Reg. 1.467-2 is applied (three-year allocation). Some leases reflect a structure where the second part of the rule is applied (prepaid rent treated as resulting in a Prepaid Rent Loan). However, very few leases properly take advantage of both parts of Treasury Reg. Section 467. As a result, leases fail to provide the maximum flexibility to Lessors, Lessees and Lenders in how the terms of the lease are structured. In addition, by limiting a lease to either the first or the second part of the above noted regulation, or by not properly applying all aspects of that regulation, the terms of the lease may not be fully optimized particularly with the aforementioned constraints imposed by the 90/110 test and by the loan to value constraint.

In addition, current practice is limited by not providing an automated system for structuring, developing, managing and administering a leases, or multiple leases.

To the extent methodologies have been developed in the patent literature, they involve altogether unrelated problems. For example, U.S. Pat. No. 5,870,720 (“Chusid”) discloses a method for implementing a restructuring exchange of an excessive undivided debt. The method of Chusid focuses on restructuring mortgage debt by determining an underlying mortgage value (first market value and excess portion value). The second step involves apportioning liability amongst various shareholders in the property in accordance with the number of shares owned. Each shareholder also owns a proprietary lease on a predetermined portion of the property whereby each shareholder pays a periodic assessment representing the shareholder's pro rata share of the periodic payment due on the underlying mortgage. However, Chusid is concerned with restructuring an over-leveraged mortgage, not with structuring a leveraged lease transaction to produce the above-noted advantages created by changes in the regulations.

### SUMMARY AND OBJECTS OF THE INVENTION

These and other disadvantages are overcome by the present invention, which provides greater flexibility in modeling lease structures to permit maximum deferral of income recognition with the earliest possible deductions, while nonetheless meeting the various guidelines required to permit the Lessor to be confident that the lease financing will be respected by the IRS as a “true lease.”

Briefly, these objects are met by a method for implementing by a computer a lease transaction which involves deferring cash rents over a first period of time, prepaying cash rents in order to cover a second period of time; and creating a pre-paid rent loan for the remaining term of a lease by making a further prepayment.

### BRIEF DESCRIPTION OF THE DRAWINGS

The foregoing brief description as well as further objects, features, and advantages of the present invention will be understood more completely from the following detailed description of the presently preferred, but nonetheless illustrative embodiments of the invention, with reference being had to the accompanying drawings,, in which:

FIG. 1 is a block diagram illustrating the entities that form the building blocks for a leveraged lease transaction and the flow of money and obligations between those building blocks according to the invention;

FIG. 2 is a block flow diagram of a computer system according to the invention;

FIG. 3 is a flow chart showing the general features of the program for modeling lease programs according to the present invention;

FIG. 4 is a flow diagram illustrating write constraint macros used in the present invention;

FIG. 5 is a block diagram illustrating a first embodiment of the present invention;

FIG. 6 is a block diagram illustrating second, third and fourth embodiments of the present invention;

FIG. 7 is a block diagram illustrating a fifth embodiment of the present invention;

FIG. 8 is a block diagram illustrating a sixth embodiment of the present invention;

FIG. 9 is a block diagram illustrating a seventh embodiment of the present invention;

FIG. 10 is a block diagram illustrating an eighth embodiment of the present invention; and

FIG. 11 is a block diagram illustrating a ninth embodiment of the present invention.

### DETAILED DESCRIPTION OF THE PREFERRED EMBODIMENTS

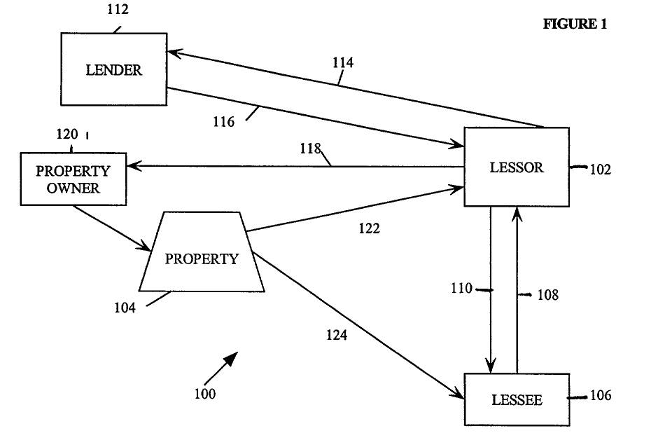

The present invention involves lease transactions between at least two parties or entities, and normally three or more parties or entities. However, the present invention is designed to be applied to any number of parties and/or entities. As shown in FIG. 1 these parties or entities comprise a lease transaction grouping 100. As generally understood, the purpose of a lease is to form an arrangement whereby one entity or person, known as the Lessor 102 has either title to or the right to use an asset or property 104 for a fixed period of time. The lease arrangement 110 is between the Lessor and the Lessee 106, the latter of which desires to have possession and/or use 124 of the property/asset 104 for a fixed term for compensation 108, known as rent, paid to the Lessor.

The lease arrangement also entails the Lessor 102 providing the Lessee 106 with a variety of terms, financial arrangements including the lease itself and in some instances loan advances 110, the details of which will be described according to various other embodiments set forth herein.

In certain leases the Lessee 106 can receive from the Lessor 102 an option to buy the Property 104. This option is known as the fixed price purchase option or the early buyout option (collectively, the “EBO”). Other issues included in the lease terms can include renewal terms, termination/default, risk of loss and property liability and administration and maintenance responsibilities, to name a few. The present invention can be employed with any form of lease arrangement, including full payout leases and leveraged lease arrangements.

The Lender 112 has the role of advancing funds 116 to be used by the Lessor 102 to purchase 118 the asset 104. As shown in FIG. 1, the Lessor sets up payment, a sale agreement or progress payments with a Property Owner 120 in order to transfer title or rights 122 in the property 104 to the Lessor 102. The funds 116 from the Lender 112 are usually based in the creditworthiness of the Lessee 106. The loan is secured by the property 104. In FIG. 1, the Lender issues a loan 116 to the Lessor 102 in order to pay the purchase price 118 to the Property/Asset owner 120. The Lessor is then shown providing payments 114 to the Lender 112. The property is then sold 122 to the Lessor 102 for use by the Lessee 124 according to the terms and conditions of the lease 110.

A key feature of the present invention is the interest rate that the Lender can charge for the lease. As previously noted, the Lender 112 frequently focuses on the Lessee's 106 credit worthiness in creating a loan. Usually the interest rate is higher since the Lessor's 102 involvement in the loan can present added risks to the Lender.

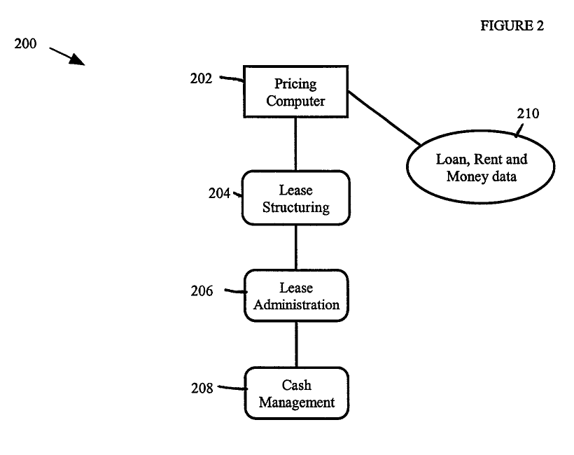

As shown in FIG. 2, the present invention is implemented by a computer program and a computer system 200, which implements the computer program. The system can take a variety of forms including one or more personal computers, servers, workstations or any other suitable form of stand-alone computer or one or more computers interconnected through a network. In FIG. 2 a single computer implementation 202 is shown. The computer is either used in a stand-alone environment, or connected to a local area network (not shown) or interconnected through a wide area network (not shown), such as the Internet. In the standalone setting the computer 202 performs a variety of functions including lease modeling 204, lease administration 206 and cash management 208. The computer 202 is also shown connected to an affiliated storage device or database 210 containing information regarding the loan, rents and money. However, any form of single or multiple computers, networks and storage units that are conventionally understood by those practiced in the art of leasing and computer systems and software can be employed. In addition, the computer program can be written in any one of a number of formats and computer languages and rely on none or alternatively on one or more databases, to provide the data upon which the programs execute.

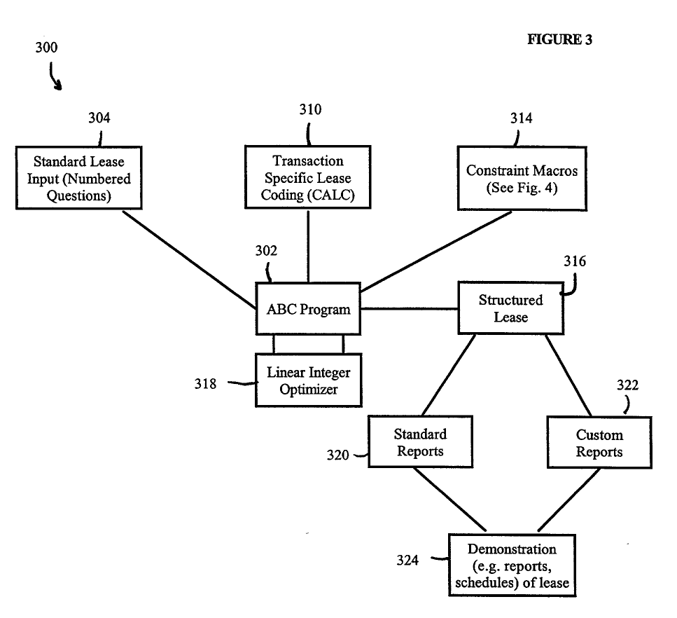

Referring now to FIG. 3, one computer program implemented by the computer system 200 of FIG. 2 is shown. In the illustration set forth the computer program uses as its foundation the ABC Program 302 licensed by Warren & Selbert, Inc. 222 East Carrillo Street, #310, Santa Barbara, Calif. 93101 (“ABC”). Specifically, ABC is a tool for optimizing structured financial transactions. ABC also can compare financial alternatives. As part of the ABC program 302, a constraint portion 314 of the program is available for a user such as a Lessor to express its constraints for the structured transaction. This part of the program uses a constraint modeling language called “CALC.”

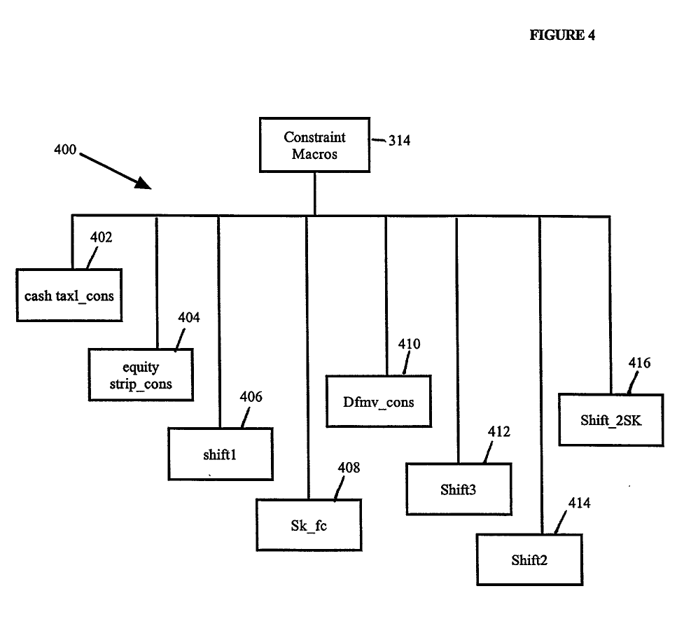

The ABC 302 program consists of three parts: a standard lease input section 304, a constraint section 314 and a linear optimizer 318. The input portion 304 requires the user to provide standard lease terms such as the lease commencement date, the closing date, asset value and the desired depreciation method. The constraint section 314 is where the rules or constraints of the lease are provided. In the instant invention, various models are expressed in CALC to effectively provide output and confirming reports 320, 322 to the user of the structure of the lease. However, it is understood that any software capable of expressing mathematical models can be used in place of CALC. Once these constraints are fully expressed, then the user can invoke the linear optimizer 318 and the transaction specific lease coding 310 to produce output and reports of the optimized rent and debt pattern based on the selected constraints. Several examples of CALC constraint macros 314 used in the present invention are set forth in FIG. 4.

FIG. 4 sets forth various write constraint macros called by the ABC program 302. These macros are selected by those parties, such as the Lessor, or consultants for the Lessor that desire to develop an optimized financial structure for the transaction. The available macros include, but are not limited to, cashtax1_cons 402, equity strip_cons 404, shift1 406, SK_fc 408, Dfinv_cons 410, shift3 412, shift2 414 and Shift_2SK 416. Specifically, these macros perform the following functions:

Macro CASHTAXL_CONS consists of code identifying loans that are in cash and tax, verifying that the AFR (applicable federal rate) in the lease corresponds with the published AFR for the month of closing and implements security features of the invention.

Macro EQUITYSTRIP_CONS consists of code calculating certain termination values used to assure that certain loans in the transaction are sufficient to cover the equity strip value (equals equity termination value less balance of the equity deposit account).

Macro SHIFT1 consists of code constraining the behavior of the Prepaid Rent Loan and deferred rent loan. In particular parameters passed to this macro control how large the Prepaid Rent Loan may become, which flows may be used to service this loan on the EBO, and when the principal and interest, on these loans must be paid off.

Macro SK_FC consists of code assuring certain free cash patterns in the Service Contract Term.

Macro DFMV_CONS consists of code implementing the loan to value constraint. This macro is often replaced in the write constraints section by the actual code (or a variant thereof).

Macro SHIFT3 consists of code controlling the sequence of phases during the lease term, namely, deferred, then prepaid, then prepaid by more than a year (equals prepaid rent loan phase). This macro is seldom used as SHIFT2 provides greater functionality.

Macro SHIFT2 consists of code controlling the sequence of phases during the lease term, namely, deferred then prepaid then prepaid by more than a year (equals prepaid rent loan phase). This control of phases is accomplished through the use of binary variables (hence making the lease structuring an integer programming problem instead of a simple linear programming problem). Above and beyond this, the code implements certain security features and, optionally, through the use of a parameter, allows the possibility of a deferred rent loan during the deferred phase of the lease.

Macro SHIFT_2SK consists of code allowing the front ending of the service contract payments which allows a larger Prepaid Rent Loan at the end of the basic lease term. This code further relates the cash and allocation in the service contract allowing for multiple assets with differing useful lives (resulting in the SK step down feature of the invention).

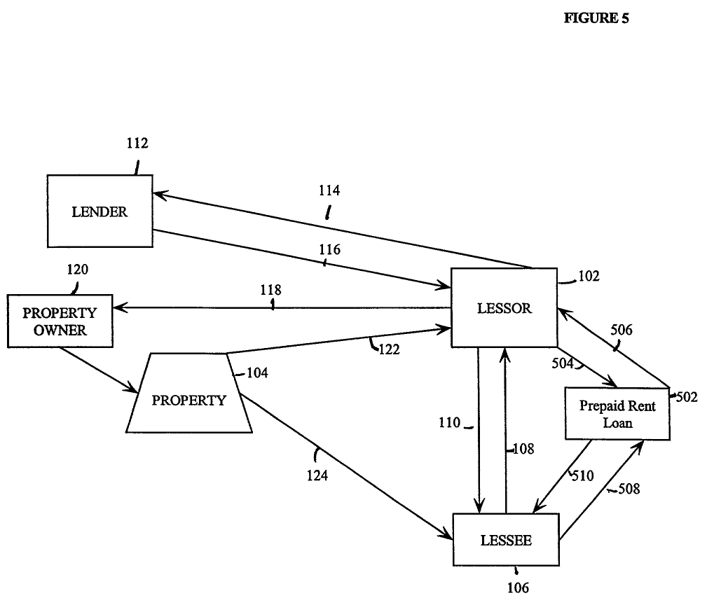

In a first embodiment shown in FIG. 5, a system and method is disclosed where a lease is structured in a manner that allows cash rents 108 from the Lessee 106 to the Lessor 102 to be deferred or prepaid within a three-year period and also allows any remaining cash that exceeds the three-year allocation limit (based on the 90/110 test) to be treated as a Prepaid Rent Loan 502. As a result of this combined structure, greater flexibility and leverage, are realized.

For example, if a $10,000 piece of equipment 104 is leased 110 over ten years, then the Lessee 106 may, for example only make cash payments 108 in the second and third years of the lease, while the Lessor 102 can allocate its lease rent 108 over the entire ten-year lease term. In this example, the Lessee 106 pays a substantial amount of rent 108 in year two (which is allocated, in part, to year one and the balance to year two) and makes a large lump sum payment in year three (which is allocated to years 3-10). For years 3-10, that payment 508 is used to create a Prepaid Rent Loan 502 which is created by the prepayment by the Lessee 106 to the Lessor 102 at steps 506 and 508 for the amount 508 that is prepaid by more than one calendar year. The remainder of the Lessee's payment 108 is allocated as rent payments in years three and four.

The Lessor 102 and Lessee 106 also realize increased leverage. This is due to the fact that the role of the Lender loan 116 is reduced. The large prepayment received by the Lessor at step 506 in year three is used by the Lessor to repay at step 114 much of the third party loan 116. Thus, the third party loan balance 116 can be reduced at step 114 below the aforementioned loan-to-value constraint, while the total leverage (the sum of the third party loan 116 plus the Prepaid Rent Loan 510) can substantially exceed the fair market value of the leased asset 104. (It is generally recognized by Lessors that the loan-to-value constraint does not need to take into account the Prepaid Rent Loan 502). As a result, a loan 502 can be made between the Lessee 106 and the Lessor 102, which together with the loan from the Lender 112 to the Lessor 102 can be substantially larger than the loans that would be permitted if only the third party Lender 112 was lending finds. Further, the cost of the lease can also be reduced. This is due to the fact that the interest rate on the Prepaid Rent Loan 502 is only required to exceed 110% of the Applicable Federal Rate, which is often lower than what Lenders 112 can charge.

As previously noted, a feature of a standard lease is the Lessee's ability to purchase the real or personal property at the end of the term. However, if the Lessee does not purchase the asset, then in many transactions, the Lessee must find someone who will agree to make specified payments for a number of years that permits the Lessor to repay the Lender for the third party loan and to maintain a specified return on its investment.

In the typical scenario, the optimal tax structure typically would be to permit the aggregate of the lease rentals plus the buyout price to be as “back ended” as possible, thus allowing the Lessor to defer the recognition of taxable income. However, many of the requirements to insure “true lease” status (in particular the interplay between the “90-110 test” which requires income to be allocated within certain narrow parameters and the loan-to-value constraint) effectively limit the back-ended nature of the rentalpurchase option price.

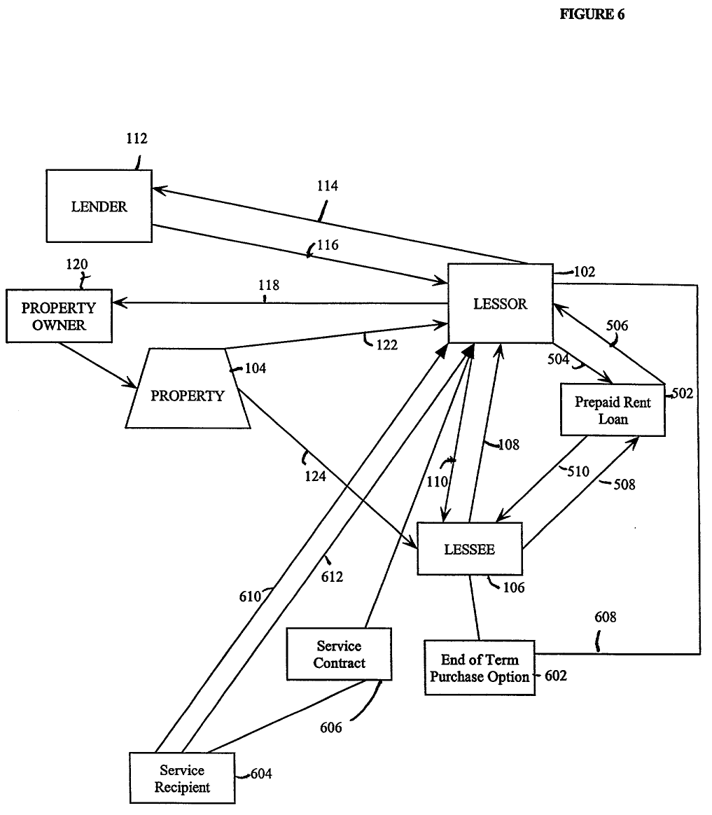

A further advantageous feature and embodiment of the present invention shown in FIG. 6 is that it permits the Lessee 106 to exercise an end of term purchase option 602, where the Lessee 106 has the option to either buy the asset 608 from the Lessor 102 , or find a Service Recipient 604 that is willing to enter into a service contract (“SK”) 606. The SK 606 creates additional flexibility and leveraging advantages for the parties since it in effect can permit the repayment of the loans 502 and 116 and the return to the Lessor can be deferred to the SK term.

In a third embodiment, also shown in FIG. 6, the first SK payment 610 from the Service Recipient 604 is used by the Lessor 102 to repay 504 the Prepaid Rent Loan 502 on the last day of the lease term (which is also the first day of the SK term). The advance “SK payment” 610 by the Service Recipient 604 is payable on the first day of the SK term and full payment 504 is made on the Prepaid Rent Loan 502. In this embodiment, all of the remaining 5K payments 612 by the Service Recipient 604 are level with payments that are set at 100% of the average during the life of the SK term.

In a fourth embodiment, more money is payable 610 by the Service Recipient 604 on the first day of the service contract term, by front-loading the first SK payment 610 at 110% of the average of the service contract term payments. The remaining service contract payments 612 can be set to meet the 90/110 test. As a result, the structure created by the embodiment shown in FIG. 6 permits a larger prepaid rent loan balance to exist on the last day of the Lease term because there is now more money coming in on that date to repay the prepaid rent loan.

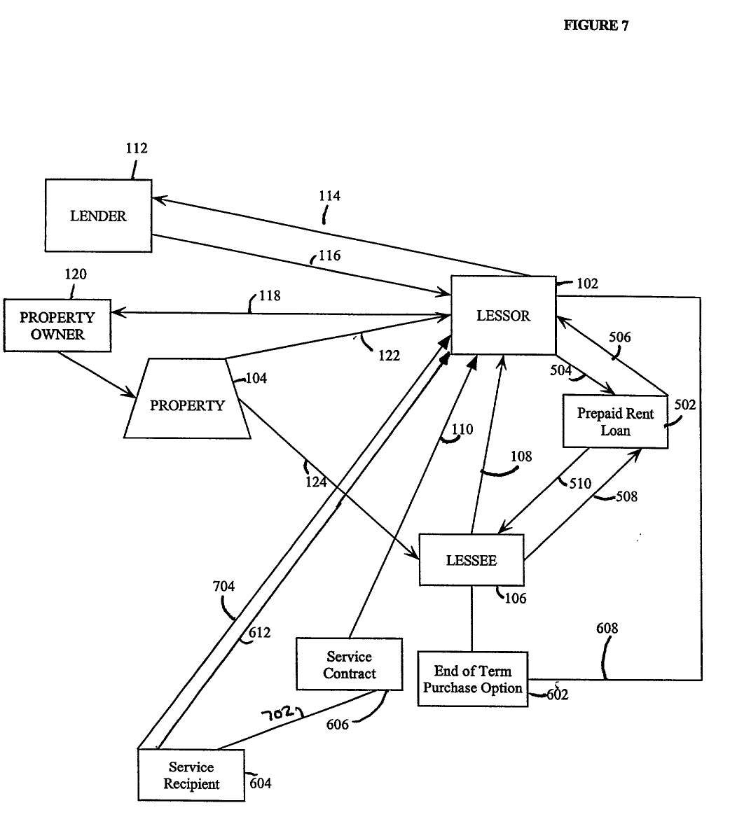

In a fifth embodiment, illustrated in FIG. 7, the SK 606 can be structured with a double service contract payment 704 from Service Recipient 604 on the first day of the service contract term, which is communicated to the Service Recipient 604 along line 702. Again, the goal is to have available as much cash as possible on the last day of the lease term in order to permit the Prepaid Rent Loan 502 to be as large as possible. As previously discussed, the IRS regulations allow cash and tax to be separated by as much as one calendar year. As a result, the double service contract payment 704 can provide for more cash to be available on the last day of the lease term, while nonetheless permitting the service contract payments 612 and 704 to fit within the one-year grace period rule.

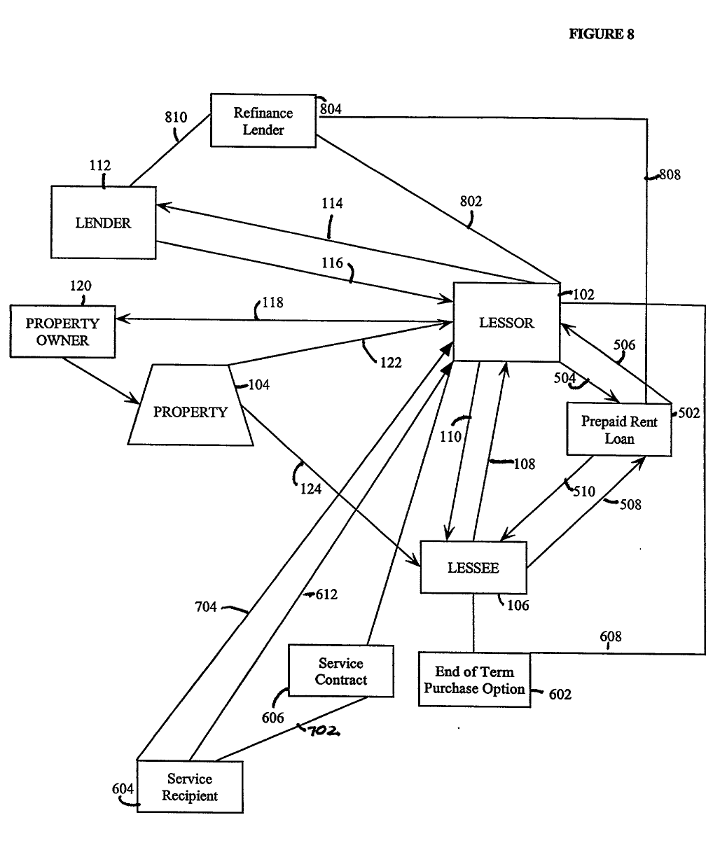

A sixth embodiment of the invention, which is shown in FIG. 8, is the ability to allow a refinancing of the third party loan 116 at the beginning of the SK 606. In this scenario, if the Lessee's end of term purchase option 602 is not exercised, then the Lessee needs to find another Lender 804 to pay out 810 the remaining lease term third party debt 114. By refinancing, one debt 116 is replaced by another as represented by line 802 (showing the flow of money from the Refinance Lender 804 to the Lessor 102). However, the refinanced loan can be larger than the old third party loan 116, with the extra proceeds 808 to be used to repay the Prepaid Rent Loan 502. This allows more money to be borrowed as of the first day of the SK term 702 based on the then value of the leased asset 104, which is often significantly higher than the day one fair market value due to the nature of the asset 104 and the effect of inflation.

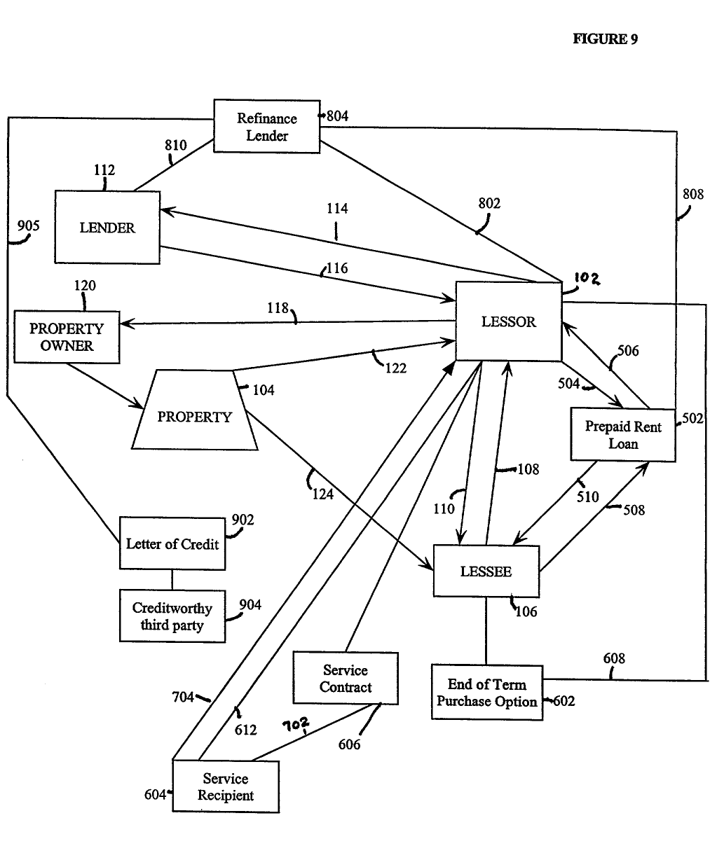

A seventh embodiment of the invention shown in FIG. 9 involves a letter of credit 902. As previously noted, the debt level is constrained by the loan to value limit during the SK term 702. One way to loosen this limit is for the Lessee 106 to procure a letter of credit 902 pursuant to which a creditworthy third party 904 agrees to repay along payment line 905 to the Lender 112 a portion of the Refinance Lender loan 802 if there is a default by the service recipient 106. Since only the portion of the Refinance Lender loan 802 that would not be backed by the letter of credit is considered for purposes of the loan-to-value constraint, this permits a larger refinancing loan 802 to be obtained and hence permit more funds to be available to repay 808 the Prepaid Rent Loan 502.

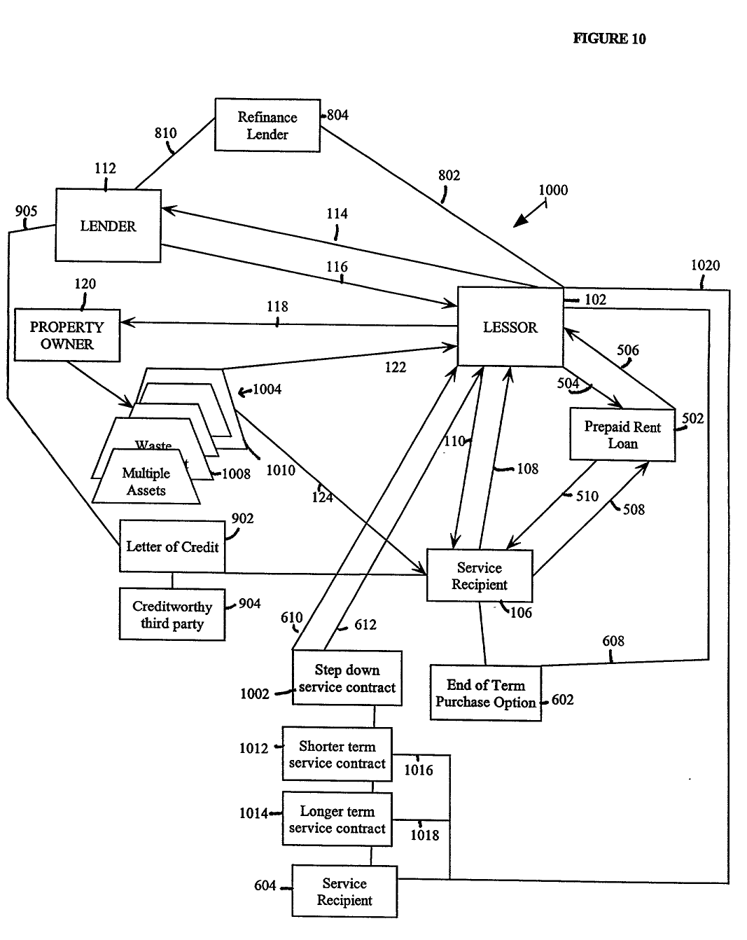

As shown in FIG. 10, an eighth embodiment involves the step-down SK 1000. A step-down is used when there are multiple assets 1004. Multiple assets 1004 often have different useful lives. In this instance a step down SK structure 1002 can be employed whereby an asset's useful life is used as the measure for the term of the lease 110 and the SK 1002. For example, a wastewater treatment plant 1008 and a municipal sewer system 1010 leading to the treatment plant have different properties. The sewer system 1010 (label not shown) would most likely have a longer useful life than the treatment plant 1008. An asset having a shorter useful life would have a shorter lease term 110. A step down tool can be used where the Service Recipient 604 can increase the balance of its shorter life SK payments 1012, 1016, which are paid to the Lessor 102 along line 1020, by adding those payments to the longer SK periods 1014, 1018. At the end of the shorter-term SK 1012, the annual SK 1016 payment is thereby stepped down to the payment level for the longer-term SK payment 1018. As a result, the lease term for multiple assets 1004 is extended to be equal to the term (i.e. 80% of the remaining useful life) of the longer life asset 1010, thus permitting greater cash flow and thus a larger prepaid rent loan at the end of the lease term.

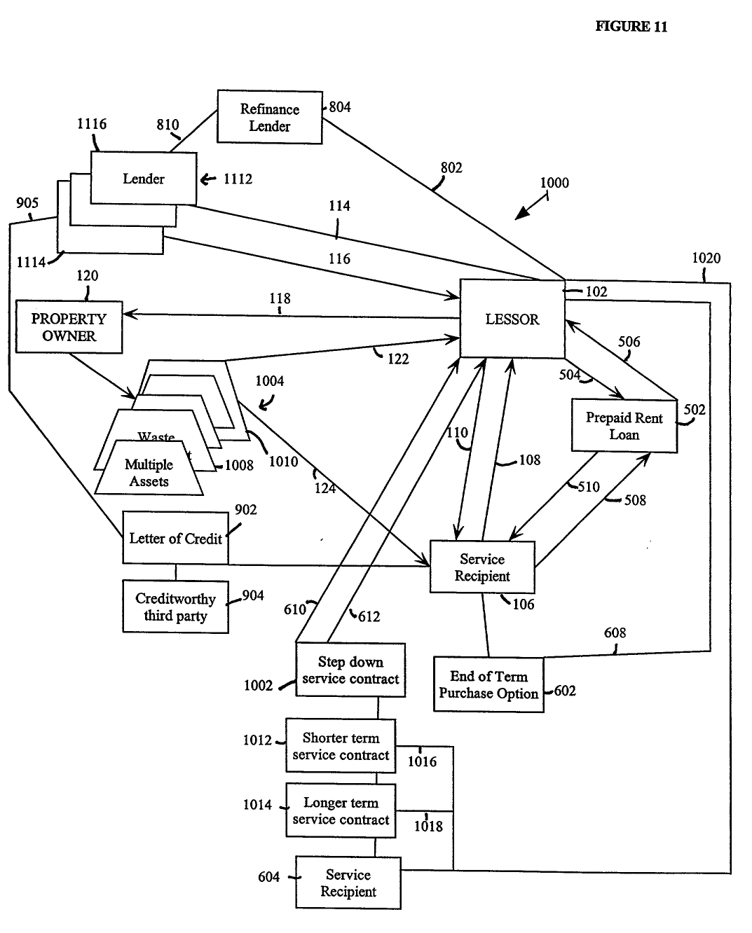

Another embodiment of the invention is shown in FIG. 11 concerning multiple Lenders 1112. Certain lease-related loans are structured so that one of multiple Lenders 1112 sells portions of its loan to one of the other Lenders. This can be advantageous where different Lenders 1112 charge different rates for their exposure, thus permitting the Lessee 106 to shift from a higher cost loan 1114 to a lower cost loan 1116 on the optimal date. This shifting allows the collateral costs to be lowered. One constraint on this structure is that there are limits on how much a loan can be “bought down.” The present embodiment provides added flexibility in permitting the prepaid rent loan 502 to be larger insofar as it offsets the cost that would otherwise be borne by the fact that the prepayment reduces future rents 108 that otherwise could be used to shift loan amounts from more costly Lenders 1114 to cheaper Lenders 1116.

A tenth embodiment of the invention (not illustrated) involves a lease structure where the Lessee prepays more than the entire rent due for the remainder of the lease term. The extra amount paid might then be characterized as another form of loan permitting the Lessor to take larger interest deductions, while using the money to repay more expensive third party debt.

Another aspect to this embodiment of the invention involves deferring the date on which the prepaid rent loan commences. Some Lessors do not want the prepaid rent loan to begin prior to a specified number of years into the transaction. Therefore, the prepaid rent loan can be designed to start at a later date.

An eleventh embodiment of the invention is the ability to extend repayment of the prepaid rent loan beyond the end of the lease term. This again permits a larger prepaid rent loan to accrue during the lease term because SK payments from multiple years can be used to repay the prepaid rent loan. The aforementioned techniques include front-loading the SK term rents, or borrowing more money on the last day of the lease term.

Another embodiment of the invention involves differentials based on different assets. When a lease involves different types of assets, they can be depreciated differendly. For example, computer software can be depreciated very aggressively, while municipal sewers cannot. In addition, if rents are based on real estate assets, then the rental levels rate can vary by a factor of 15% rather than the 10% limit imposed on personal property (i.e., an 85-115 rent structure rather than a 90-110 rent structure). In the present invention, the differences in rent rules can be combined with other aspects of the invention to permit maximum deferral.

A further embodiment of the invention involves the loan 802 by the Refinance Lender 804 being set as a floating rate loan. This results in a lower interest rate during the SK term, thus allowing greater back-ending of the rent structure.

Another embodiment of the invention involves the ability to utilize the foregoing embodiments in connection with the acquisition of a leasehold interest in a “safe harbor lease” under Section 168(f)(8) of the Internal Revenue Code of 1954. Special rules apply to the amounts paid for acquiring such a leasehold interest, and the invention permits the optimal structuring of a lease financing in connection with those rules.

A further and important feature of the invention is the ability to utilize all or most of the above noted components in connection with a single transaction. Thus, by combining different aspects, it is possible to maximize the deferral techniques while at the same time meeting the various constraints necessary so that the Lessor can be comfortable that the transaction will be characterized as a true lease.

Although the preferred embodiments of the invention have been disclosed for illustrative purposes, those skilled in the art will appreciate that many additions, modifications, and substitutions are possible without departing from the scope or spirit of the invention as defined in the accompanying claims.

We claim:

1. A method for implementing by a computer a lease transaction comprising the steps of:
deferring cash rents over a first period of time;
prepaying said cash rents to cover a second period of time; and
creating a pre-paid rent loan for a remaining term of said lease by making a further prepayment.
